(19) United States
(12) Patent Application Publication
(10) Pub. No.: US 2009/0119159 A1
(43) Pub. Date: May 7, 2009

(54) System and Method for Transferring Funds to Recipients of Electronic Messages

(75) Inventors: David C. Reardon, Dardenne Prairie, MO (US); Mark Yow, Chatham, IL (US)

Correspondence Address: THOMPSON COBURN LLP, ONE US BANK PLAZA, SUITE 3500, ST LOUIS, MO, 63101, US

(73) Assignee: David C. Reardon, Dardenne Prairie, MO (US)

(21) Appl. No.: 12/261,764

(22) Filed: Oct. 30, 2008

Related U.S. Application Data
(60) Provisional application No. 61/001,056, filed on Oct. 31, 2007.

(51) Int. Cl. G06Q 30/00; G06Q 20/00; G01C 21/00

(52) U.S. Cl. 705/10; 705/40; 705/34; 701/213; 705/14; 705/21

(57) ABSTRACT

Funds are transferred via electronic messaging systems and methods, including a mobile electronic device (MED). Exemplary applications include: delivering a targeted advertisement to a MED based on location or proximity, charging receipt charges for telephone calls, using a MED to pay for goods at a retail outlet, and security techniques for preventing unauthorized financial transactions from a MED.

### CROSS-REFERENCE TO RELATED PATENT APPLICATION

This application claims the benefit of provisional patent application 61/001,056 filed Oct. 31, 2007, and entitled “System and Method for Transferring Funds to Recipients of Electronic Messages”, the entire disclosure of which is incorporated herein by reference.

### BACKGROUND

The disclosure is generally directed toward the field of electronic financial transactions, particularly the initiation of financial transactions from a mobile electronic device.

### GLOSSARY

The following glossary of technical terms used repeatedly throughout this disclosure will be of substantial benefit for the reader to understand the invention:

Electronic Communication Device (ECD) is any device with computing and communication functions which is capable of communicating with other electronic devices such as computers, cell phones, personal digital assistant (PDA), interactive television sets, or other such devices via wired or wireless transmissions, including the internet, Wi-Fi, Bluetooth, RFID, or similar existing or future services or protocols. ECD include mobile devices as well as ECDs that are placed at fixed locations such as network server farms, cell phone towers, and other permanent or semi-permanent installations.

Mobile Electronic Device (MED) is a mobile ECD, usually a hand held device, equipped with the ability to communicate with other ECDs via cell phone networks, the internet, Wi-Fi, Bluetooth, RFID, or similar existing or future services or protocols. Common MEDs include cell phones or other mobile phones or a personal digital assistant (PDA), but MEDs may also include electronic communication device mounted on a vehicle or a portable vendor's kiosk or other system which is intended to be transported from place to place with relative ease.

Radio Frequency Identification Devices (RFIDs) are radio devices that respond to a scanning unit's signal when they're brought near the scanner by transmitting back a digital code with a serial number that uniquely identifies the tag. The chips can be battery-powered, or, they can use the scanner's radio beam as their power source.

Bluetooth is a standard and communications protocol primarily designed for low power consumption, with a short range (power-class-dependent: 1 meter, 10 meters, 100 meters) based on low-cost transceiver microchips in each device. Bluetooth enables these devices to communicate with each other when they are in range. The devices use a radio communications system, so they do not have to be in line of sight of each other, and can even be in other rooms, as long as the received transmission is powerful enough.

Location detection functions include any method of detecting the global location of an MED, as for example by GPS, or the proximity of an MED to another MED or another electronic communications device at a fixed location. Location detection functions may be implemented with Wi-Fi, Bluetooth, RFID detection, cell tower identification or triangulation, or via Location-based services (LBS) or Location Services (LCS) which are services developed and distributed by wireless carriers and their partners which provide information specific to a location, and similar existing or future methods.

Local station refers to a device employing local detection functions which is preferably in communication with the Suma system and configured to identify the presence of MEDs in proximity to the local station.

Digital Identification, or DI, refers to a legally binding electronic signature, a digital signature (DS), or an electronic confirmation of identity that may be in the form of an asynchronously encrypted, verifiable certificate of authority (CA) issued by a trusted third party, such as a bank or post office, that attests for the identity of the designated holder.

Header refers to information associated with a Summa message (see definition below) that is not normally viewed by the receiver but is used by the servers and clients to process the message and balance the accounts.

Network server refers to software and hardware employed by the service provider to collect and distribute information between Summa account (see definition below) clients.

Receipt charge is the charge set by the receiver of a Suma message (see definition below) to be applied against the account of a sender and credited to the receiver as generally or specifically defined in the charge schedule.

Receiver refers to the user of a Summa account (see definition below) who receives a Suma message (see definition below).

Sender refers to the user who sends a Suma message (see definition below).

Service provider refers to an entity that provides Summa accounts (see definition below) to a plurality of users through at least one Suma network server. Typically, the service provider may be a bank or other financial institution, an internet service provider, or another business offering or managing credits accessible to users through a Suma account (see definition below).

Suma account refers to an electronically managed financial account that includes an integrated electronic messaging system or, conversely, an electronic messaging system that is integrated into the electronic management of one or more financial accounts. Alternatively, a Summa account may be composed of an electronic messaging system that includes the programming and authorizations necessary to credit or debit to one or more financial accounts.

Suma client refers to the software and/or device used to communicate with the Summa network for composing, sending, receiving, and reading a Suma message (see definition below) and accessing the associated financial account(s) and account records. This software may be resident on a user's machine or may be accessed by a user's ECD via network service such as a web application.

Summa enabled refers to devices and servers with access to the Summa system via Summa client software, Suma web applications, or other communication protocols, and may include Summa enabled ECDs, MEDs, local stations, ad placement units, financial institution servers, payment gateways, cash registers, or other equipment or networks not owned by a Suma service provider but which have been granted access to the Suma system.

Suma message refers to an electronic message containing information regarding a transfer of funds between Summa accounts and which may also include additional information, messages or attachments from the sender to the receiver. In addition to designating a transfer of funds, the Suma message may include electronic text, images, audio, video, or telephonic communications. The processing of a Suma message may be referred to as a Suma transaction.

Suma server refers to a computing device within the Summa system which operates one or more of the software modules and may have access to one or more of the Suma databases.

Suma user refers to any person or business entity with a Suma account on the network. A Suma user may be either the receiver or sender of a Suma message.

“Suma system” or “Summa network” are used herein to refer generally to the various components operated by a Summa service provider, including parts involved in the processing of a Suma message transaction. The Suma system includes, but is not limited to a network interface, servers, routers, switches, load balancers, memory, software, data bases, online and offline storage systems, internet connections, and telephonic connections. The data bases and processing modules may include system transaction rules, user defined transaction rules, web applications, consumer client software, marketer client software, message certification modules, message tracking and delivery modules, transaction modules, accounting modules, ledger modules, clearinghouse modules, account management modules, marketing data modules (containing both user provided profile data and/or a history of behavioral metrics related to purchases made or responses to messages delivered), data mining modules, an authentication module, ad submission modules, ad classification modules, ad placement modules, message sequencing modules, criteria matching modules, and credit exchange modules, shopping modules, banking and credit card modules and other components which may facilitate Summa transactions, data gathering, and data use.

The Suma network preferably provides for two-way communications and financial transactions between users so that either party may compose a message and transfer funds to any other party within the Suma network. In addition, the same account ID preferably applies to both the messaging and financial services and every transaction is typically completed with the processing of both the message part and the funds transfer part. While one could send a Summa message with zero funds, the accounting system would show a transfer of 0 funds associated with receipt of that message part. Similarly, while one could send a Summa message with five dollars and no message, one would receive the five dollars with an empty message. In most cases, however, at least a small financial transaction, designated to pay a delivery charge, would be associated with each message delivered.”

### DESCRIPTION OF THE DRAWINGS

FIG. 1 is a block diagram showing the relationship between Suma users, network servers, and the databases associated with each user's Summa account;

FIG. 2 is a spreadsheet that illustrates an example of the type of information maintained in the database associated with a user account;

FIG. 3 illustrates a simple flow chart of a software subroutine used by the user, according to the invention, to set the schedule of charges to be demanded of those who wish to send messages to the user;

FIG. 4 illustrates a flow chart which is exemplary of a software subroutine used by the network server, to resolve handling a Suma message sent from one user serviced by one server to another user serviced by another server;

FIG. 5 is a block diagram similar to FIG. 1 but with the financial accounts residing outside the Suma network database, illustrating the ability to complete a funds transfer may be provided with authorization and access to electronically order transfers of funds to and from a user's financial account held an external financial institution;

FIG. 6 depicts an exemplary embodiment for delivering targeted advertisements to MEDs from a local station;

FIG. 7 depicts an exemplary embodiment for the use of an MED to facilitate transactions at a retail store; and

FIG. 8 depicts an exemplary system for securing the use of an MED by requiring that an independent payer identification device (IPID) be in proximity to the MED.

### DETAILED DESCRIPTION

As disclosed herein and in U.S. application Ser. No. 11/063,076, prior to making a financial transfer, each Summa user preferably has established a financial account with his Summa service provider. This account includes either or both deposits of funds or a line of credit. Optionally, a sender may fund Suma messages via credit card or other payment.

Through the Suma client, by which the user accesses and manages one or more Suma accounts through the Summa system, the user defines a schedule of receipt charges that senders must pay to the user (when the user is the receiver) as compensation for accepting delivery of their Suma messages. Upon delivery of a Summa message, the sender's Suma account is debited the agreed upon charge(s) and the sender's account is credited the charge, minus any service fees that may be imposed by the service provider.

In addition to providing a technique for receivers to establish and collect message receipt charges, this invention also provides a secure manner of transferring other funds between any two Suma accounts. This facilitates internet purchases, micropayments, electronic invoicing and bill payment, and any other transfer of funds that user may require. Since this payment involves a transfer of funds directly between Summa accounts, there is no need to transmit credit card numbers or account numbers over the internet.

In addition, with the permission of users, the service providers can also track the types of purchases made and add this to the marketing database kept on each user. Collecting and making this data available increases the value of each user's market identity and thereby increases the income that users will be able to receive from receipt charges.

In regard to the schedule of receipt charges, users will typically provide that persons from whom they most wish to receive Summa messages will be charged nothing or only a little. A “standard charge” of five cents, for example, would help protect the user from spam. Furthermore, the schedule of charges to be applied for receipt of commercial messages may be set by commercial categories. The charge for receiving messages would typically be set low for the type of commercial messages most desired by a particular user and highest for the least desired commercial messages. High charges would also be applied to categories where the users know they are high-valued prospects.

By establishing a charge schedule for receipt of commercial messages, the individual is providing marketing information that is useful for commercial enterprises. The service provider can sell or lease this electronically generated list of addresses to businesses who are then able to send commercial messages that receivers want, or are at least open to receiving, at a known charge.

Through this process the following advantages are obtained: (1) “spamming” of untargeted commercial offers or private messages is eliminated because users only receive messages that they agree to receive according to their schedule of charges, (2) receivers are provided with income for the value of their time and market identity, (3) Suma service providers obtain additional service charge and advertising revenue, (4) commercial enterprises can more readily obtain lists of individuals interested in receiving their commercial offers through Summa messages, and (5) electronic financial transactions can be completed in a secure manner with better tracking and verification.

Thus, there is the provision of a user-friendly financial transaction system using the Internet that will enjoy the confidence of its users. There is also the provision of such a transaction system which offers a user greater control over the time he spends reviewing both expected and unexpected communications, greater value from information shared about his market identity, and greater convenience and security in the completion of financial transactions.

There is further the provision of a transaction system which connects a secure messaging system to an electronically controlled financial account for each user that allows both the sending and receipt of funds as part of an email to another party using a similar Suma account, allows a user to specify a schedule of receipt charges required to receive email from specific individuals, groups of individuals, or classes of businesses, and collects marketing information about the user's purchases made using this financial account, with the user's permission, so that it may be sold to marketers and thereby increase the income that the user will receive from receipt charges.

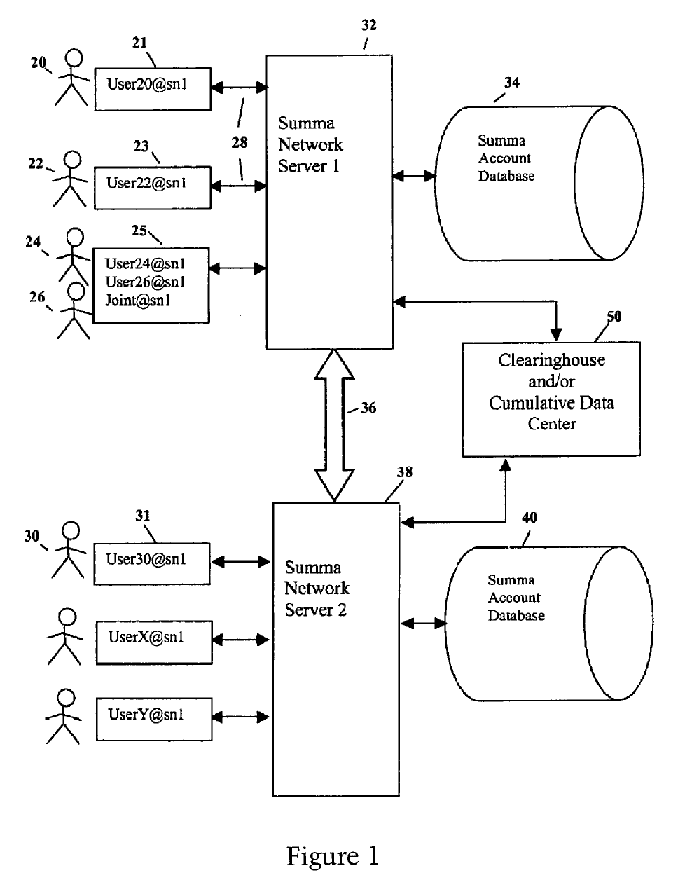

Referring now to the drawings and, initially, to FIG. 1 which illustrates the techniques achieved and controlled by the use of a computer network wherein network servers 32 and 38 exchange Suma messages through an electronic connection 36.

As seen in FIG. 1, Individual users 20, 22, 24, 26 and 30 each have access to at least one Suma client. User 20, for example, has access to Suma client 21. Users 24 and 26 have access to a shared computer running a Summa client 25 which has settings to send and retrieve Summa messages for three account addresses, one for User 24, user24@snl, one for user 26, user26@snl, and one that is shared by both user 24 and user 26, joint@snl. Through their respective Suma clients, users communicate with their assigned network server, 32 or 38. For example, Summa client 21 is shown as connected to network server 32 via an internet connection 28. If user 20 sends a message addressed to user 22, network server 32 will store the message received from Suma client 21 in memory until it is retrieved by user 22's Summa client, 23.

The exchange of messages between users that are serviced by different servers is only slightly more complex. For example, assume that user 24 wishes to transmit a message to user 30 who is served by server 38. The address of the receiver, user 30, would be recognized by server 32 as directed to a user associated with network server 38, and relayed to the network server 38 via the network connection 36. The message routing software of the server 38 will automatically parse the address for the receiver and identify that the message is to be delivered to user 30. If it was determined that the message was to be delivered, it would be stored in a file accessible for retrieval via that user's Suma client, 31.

The foregoing description is commonly understood by those familiar with the art of electronic messaging. the Suma network servers also maintain financial accounts and databases 34 and 40 for each user which include a schedule of charges to be charged against the accounts of senders and credited to each user on delivery and the means to debit or credit the financial accounts upon delivery of the Summa message.

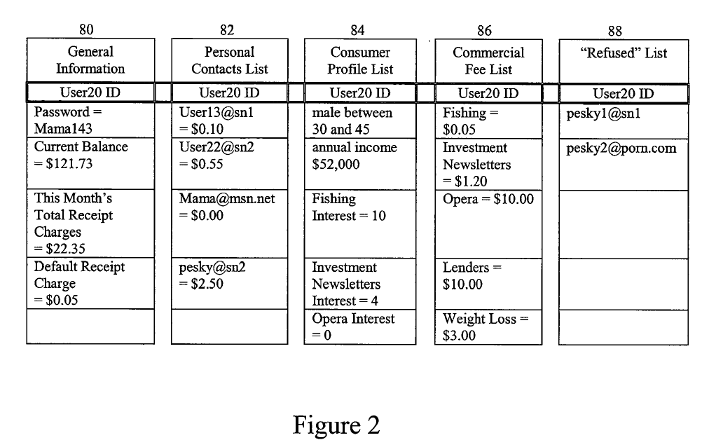

A general example of the charge schedule and consumer profile for user 20 is entered and stored in database 34, as shown in FIG. 2. In this figure, each column represents a separate category of information. For the sake of this discussion, each column, 80 through 88, represents a discrete file. Other arrangements of the data will be obvious to those skilled in the art. As shown in FIG. 2, the first row of each file is a label for the type of information stored in that file and the second row is a unique identifier for user 20, shown simply as “User20 ID” in this example, which is used to identify, link, and access the appropriate data for user 20 across the several files.

In this example, a general information data file 80 is the memory location in which running totals of user 20's credits, debits, and service charges are maintained, along with other standard information such as passwords and the default receipt charge. A personal contacts list file 82 is a list of users known to user 20 for whom user 20 wishes to establish a receipt charge that is different from the default receipt charge. Any address identified as having a receipt charge equal to zero is tagged for the pass through list. A consumer profile list file 84 contains data regarding the consumer profile for user 20, for example, likes and dislikes, product preference, recent purchases, and demographic information. A commercial fee list file 86 contains the charge schedule defined by user 20 that should be applied against various types of commercial accounts. A “refused list” file 88 is a list of user addresses that user 20 wants to have automatically returned or discarded regardless of the maximum receipt charge they are willing to pay.

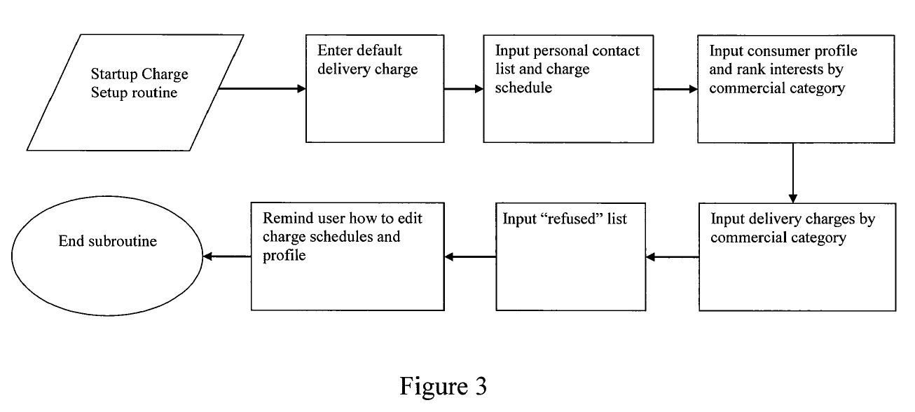

At the time of establishing a new Suma account, or at such other times as the service provider or customer may wish to modify his account settings, the owner of the Summa address completes or amends an electronic form that establishes the basic charge schedule. FIG. 3 is a flow chart demonstrating the basic steps of a software subroutine by which a user would supply the information stored in the database illustrated in FIG. 2. The ordering of these steps is not crucial. Persons skilled in the art of computer programming will readily derive many variations on this procedure. The basic steps of this subroutine would set the user's default receipt charge, allow entry of specific charges to be applied against specific categories of commercial messages, and input of any additional information that may contribute to a consumer profile. The identification of persons who should have a receipt charge different than the default receipt charge and addresses that should be refused are additional modifications of the basic requirements. Specific addresses on these lists may be entered individually or uploaded in the form of the address book files commonly used by email programs. These steps illustrated in FIG. 2 are not exhaustive of all the types of data that can be gathered and stored in the database that would be useful in controlling the exchange of charges and credits in the general manner covered by this invention.

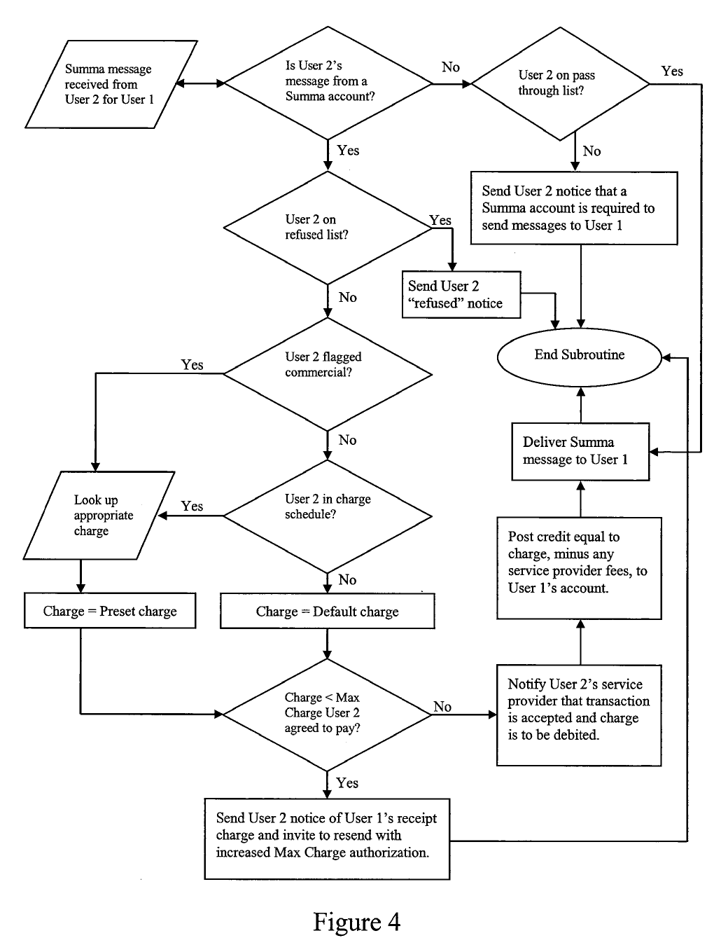

FIG. 4 is a basic flow chart that outlines major steps of a server subroutine that examines an incoming Suma message to a receiver and either (1) applies the appropriate charge to the sender's account, provides the credit to the receiver and delivers the Suma message to the receiver, or (2) returns the message to the sender with an appropriate message identifying the reason for refusal. The latter may occur if the sender is on the receiver's list of senders whose messages should always be refused, or if the sender does not have a Summa account or lacks sufficient funds in his account. A message will also be returned if the receiver receipt charge exceeds the maximum amount the sender has listed in the message as the amount he will agree to pay toward a receipt charge. For example, if the user has set a charge of ten cents for receipt of messages from financial newsletters but the sender of such a commercial message has sent the message out with a notice that he will only pay receipt charges up to seven cents per receiver, the sender will receive a notice back stating that the message was not delivered and identifying the appropriate charge that the sender must agree to pay before the message can be delivered. In this manner, senders of commercial broadcast messages can accurately control their costs and also determine what portion of a Suma list they are missing if they have set their maximum charge too low. In a typical embodiment, if the maximum charge the sender is willing to pay exceeds the receiver's receipt charge, only the actual receipt charge is charged against the sender's account.

Because the system provides a mechanism for the completion of financial transactions and credits, service providers may wish to charge processing fees and the federal, state, and local governments may wish to apply various taxes against these transactions. This involves a splitting of funds, a feature that may also benefit businesses, for example, when splitting payments between a salesman's royalties and the vendor filling an order. In any event where collected monies are required by law, contract, or other agreement to be split between multiple accounts, it is a simple matter to include programming that deducts the appropriate amount from the appropriate side of each transaction and immediately deposits that amount (which may be, for example, a tax, fee, or profit share) into the appropriate account required by governing law or contract or designated by the users. Depending on the requirements, a copy of the original message could be sent to each party receiving a portion of the payment or an alternative message may be automatically generated to satisfy each receiving party's accounting needs. Such messages, if any, might be no more than a tracking number or shipping address. The process of adding additional program steps to apply and track these additional charges is obvious to those skilled in the art.

The steps demonstrated in FIG. 4 are not exhaustive of all possible permutations of a subroutine that would control the delivery of a Summa message. Instead, this flowchart simply shows a typical examples and many permutations of this approach will be obvious to those skilled in the art of programming.

In a typical embodiment, the secure delivery of the message might require a request to send (RTS) from the sender's server and a permission to send (PTS) from the receiver's server. This step would provide for verification of charges and identities prior to transmission of the Suma message. As an additional security precaution, the RTS might also include a hash sum of the message that will be sent following receipt of the PTS. This would allow the receiver's server to verify that the message received matched the one for which a PTS was granted. Once a PTS was received, the sender's server would place the funds being transferred into a temporary escrow account against the event that the message is not successfully delivered. Once the confirmation of delivery was received from the receiver's server, the escrowed funds would be credited to the receiving party.

In the above example, the transfer of funds is only finalized after the successful delivery of the message has been confirmed. Alternatively, in other circumstances it may be desirable to hold the message until the final transfer of funds has been confirmed. Which alternative is employed may be determined by the type of message or by the selected options of users. Moreover, it is a simple matter to record along with message identifying information, such as a message hash, both the date and time that any Suma message was originally sent and the date and time that it was delivered. This information may be useful in many circumstances as an official date and time stamp which can be confirmed by comparing a copy of the record kept by users against the records kept by the third party service provider.

This flow of funds from users served by one Suma service provider to users served by another service provider will result in a continuous shift of the value of net assets held in user accounts at each service provider. In the preferred embodiment, where the service providers are financial institutions, the balances between service providers might be adjusted through ACH-like transactions that would occur at fixed intervals, for example, at the end of the day. In a typical embodiment, as shown in FIG. 1, this process could be automated through one or more central clearinghouse servers 50 that would monitor, calculate, and process the periodic transfers required to put the net balances of each Suma service provider in proper order. Typically, the central clearinghouse 50 would also maintain the list of all network server addresses for all the Suma service providers and each transaction would begin with a query to the clearinghouse to find or confirm the address of the receiver's service provider. Similarly, receiving servers could verify the integrity of sending servers through the clearinghouse. In this way, any attempt to initiate a Summa message and transaction through an unauthorized server is automatically thwarted. Those skilled in the art will also readily identify other common security and data gathering functions that would conveniently be managed by the clearinghouse servers.

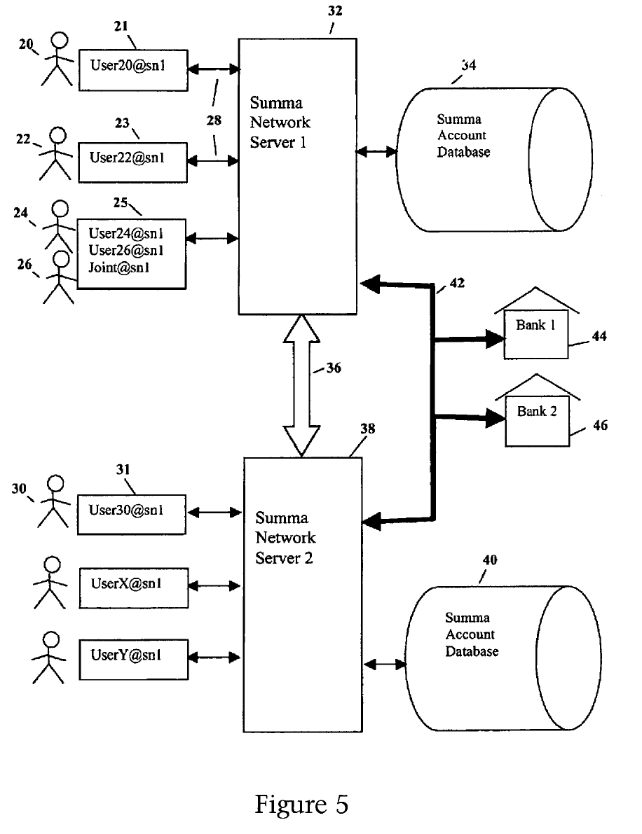

In the preferred embodiment illustrated in FIG. 1, the messaging system is integrated with the electronic funds transfer and accounting system of a financial institution. Alternatively, as shown in FIG. 5, the Suma transaction is completed using an external electronic component 42 for ordering a transfer of funds. For example, if user 20 has an account at bank 44 which provides internet banking access, user 20 can provide his user ID and password to his Summa client 21 which can then be used by the user's server 32 to access and transfer funds through the internet banking interface 42 for the selected bank account. Typically, a record of these transfers would still be kept in the Suma account database 34. In such a case, while the Summa messaging system is not actually integrated into the bank's financial accounting systems, sufficient access and control the financial account can be granted to the Suma system to complete the fund transfers required to serve the purposes of this invention.

Alternatively, or in addition, the user could sign an agreement allowing the provider of the Summa messaging service authorization to make automated clearing house (ACH) transfers to any of the user's existing accounts. In this alternative embodiment, the means of transferring funds 42 represents any means of electronic funds transfer, including but not limited to the ACH system, a credit card processing system, individually or in combination with a clearinghouse 50, through which the Suma network servers may coordinate the transfer of funds between financial accounts. For example, in the case where an ACH transaction will be involved, the user's selected account routing number would be provided through the user's Suma client. Since ACH transactions are typically processed using batch files, it may not be necessary or advisable to create an ACH transfer order for each discrete Suma message. For example, assume that during one day, user 20 has made ten Summa payments and received thirteen Suma payments, with a net gain of $5.31. In this case, the network server would accumulate a daily transfer tally in the database 42 representing the sum of credits and debits to each Suma account. Rather than issue 23 ACH transactions for user 22, the network server would order one ACH transaction, a credit of $5.31, at the end of the day. This process not only reduces ACH transaction fees, it also reduces the number of financial transactions that need to be represented in a banking statement. Because the total funds credited and debited, including service fees, must balance at the end of each day, this system is further simplified by directing all end of day Summa account credits into a central financial account owned by the service provider and directing all end of day Suma account debits out of the same central financial account. In this alternative embodiment, the user's bank statement would show only a single ACH transaction for each day representing the net Suma account credits or debits for that day. The details of each transaction, however, could be accessed through the Suma account database, which in the case of the example above would show the detail of User 20's ten outgoing Suma payments and thirteen incoming Suma payments. Alternatively, instead of balancing each account daily, the service provider could wait to balance each user's account only when the net credit or debit exceeded a minimum amount, for example $20, which would be sufficient to justify the expense of an ACH transfer fee. A similar process may be used when accessing a line of credit, using for example, a credit card number.

In another embodiment, the shift in net balances may occur between the accounts of a single service provider who owns financial account in multiple financial institutions, 44 and 46, shown in FIG. 5. To minimize transactions between 44 and 46, users might be required to have their own financial accounts controlled by their Summa account, at least the one that will receive and pay small amounts, at 44 or 46. In this alternative, User 22 may have selected bank 44 and User 30 bank 46, and both have Summa accounts managed by one service provider operating network servers 32 and 38. With the appropriate permissions from the Summa users, and by way of service provider's accounts at each bank, payments between 22 and 30 may be completed without any transfer of funds between banks. Instead, the funds paid out by 22 go into the service provider's account at 44 and out of the service provider's account at 46 into 30's account. In this way, at reduced cost, two in-bank transfers replace one between banks transfer. In this case, the net deposits in each bank remain unaffected, but the service providers' accounts at each bank are affected. This is easily managed by periodic ACH transfers between the service provider's own accounts at 44 and 46 which may be required only infrequently. This process may again be coordinated by a Suma clearinghouse, 50, which is implicitly included in electronic funds transfer means 42.

In several of the settlement scenarios, described above, users may be required to authorize the service provider to consolidate debits and credits in escrow accounts. The escrow accounts exist in the form of files stored on the network servers or clearinghouse servers 50. In combination with a record of the current balance in each account, the network server can use the running-escrow account to verify sufficiency of funds available and to prevent an overdraft. Typically, the escrow may consist of two parts: pending transactions and completed transactions. Pending transactions involve those funds that are committed to be paid upon delivery of a Suma message that is in the delivery queue but has not yet been delivered—perhaps because the receiver has not yet downloaded his Suma messages. Funds authorized for payment in pending transactions are held in escrow since they not available to either the sender or receiver. If (a) the delivery is rejected, (b) the sender cancels the delivery, or (c) the sender chose the option of putting a time limit on delivery after which delivery attempts will cease, the escrowed funds associated with that message will be returned to the sender's account. Otherwise, once the network server receives confirmation of the delivery, the payment between sender and receiver is finalized by recording a shift from a pending to confirmed debit in the sender's escrow account and recording a confirmed credit into the receiver's account. By combining the last day's settlement balance with the current day's confirmed credits and deducting both pending and confirmed debits, the network server can provide a Summa user with a real time balance of available funds. As described previously, end of day batch files may be used to settle the net deposits held by financial institutions or service providers. In this example, the end of day batch settlement would include the cumulative confirmed debits and confirmed credits held in the escrow accounts. Any pending transactions would remain in the escrow account until delivery, cancellation, or refusal of the Summa message.

Another important feature of the present invention is that, with the permission of users, the service providers can also track the types of purchases made and add this to the marketing database kept on each user. Additional marketing information may be collected by providing users opportunities to complete surveys. Demographic, purchasing, and survey data may be retained on the network server or communicated to a central clearinghouse or centralized data center that stores cumulative marketing data 50. Collecting and making this data available increases the value of each user's market identity and thereby increases the income that users will be able to receive from receipt charges.

Traditionally, for example, after a consumer has bought a product he will frequently receive additional product offers from the seller. In addition, his contact information and market profile may also be sold to other marketers, to the financial benefit of the seller, not the consumer. By contrast, while Summa purchases will also mark a consumer as a “hot prospect,” the financial benefit of the enhanced market identity associated with being a buyer flows to the consumer who will receive his required receipt charge for any additional marketing offers delivered via a Summa message. To maximize the value of the user's Suma account, use of the marketing data may be restricted to offers made through a Suma message. Alternatively, the service provider could act as a broker for sale of marketing information and credit each Suma user with a payment each time a marketer purchased data, including mail addresses or telephone numbers, associated with the consumer. Once the marketing data is collected into an electronic database, it is a simple matter to allow marketers to select prospect lists by entering selection criteria into a program that will extract the desired list of prospects. Such data mining is a common practice familiar to those skilled in the art of programming and does not require further elaboration. Furthermore, those skilled in the art of network design will immediately see that the clearinghouse and the centralized database for marketing information may be either separate or combined without compromising the functionality of the described system.

The linking of financial accounts with a secure electronic messaging service, to form a Summa account, provides a basis for accomplishing numerous functions that would be more difficult, or impossible, without a Suma account. Once this mechanism is provided, implementation of additional variations beneficial for particular applications will be obvious to those skilled in the art. Many of these additional features may be implemented by headers included with the Suma message that facilitate this process or provide additional functions. Through variations such as those described below, virtually any business or accounting practice done through traditional paperwork may be accommodated and made more efficient while still giving users greater control over their communications and financial transactions.

First, as described previously, the header could include a field identifying the maximum charge that the sender is willing to pay as a receipt charge. If the maximum charge, for example, is ten cents and the receiver's delivery charge for receipt of messages in that commercial category is five cents, only five cents would be charged against the sender's account and credited to the receiver. On the other hand, if the receiver's receipt charge was twenty cents, the message would not be delivered and the sender would be notified of the higher charge for delivery.

Second, it would be most convenient if the header included an identification of the commercial category under which the sender's Summa message should be classified. By contractual arrangement, users (both as receivers and senders) would agree to provide information used for accurate classification of commercial offers and would be bound by the decisions of this classification system.

Third, a header element might identify the amount that will be charged to the receiver if he decides to respond to the message that he has just received. In commercial applications, for example, the receiver might be notified that he will not be charged anything if he responds to the sender with an inquiry for more information. Alternatively, the sender can set the charge for responding to an amount equal to the purchase price of the product offered to the receiver. In this way, the exchange of two Summa messages (the offer and the acceptance in response) can be use to complete a financial transaction. The response charge may be different than the normal receipt charge and may revert to the normal receipt charge after a specified period of time.

Fourth, the header could include an additional field identifying a full credit transfer amount that should be fully transferred to the receiver's Summa account. If so designated, this full credit transfer amount may be transferred even if the receiver's receipt charge is less than the designated full credit transfer amount. In this manner, the sender may transfer funds to any user of a Summa account in order to pay a bill, purchase a product, give a refund, send a monetary gift, or any other purpose for which funds are transferred.

Fifth, the header may include information identifying types of messages that should be displayed or processed in specific ways. In this example, message tagged as an invoice document type might be structured in such a way that the invoiced item numbers, description, quantity, per piece charge, and total charges can be automatically captured by the receivers accounting software. XML and XHTML are formatting languages that might be easily adapted for this purpose. The Suma client would recognize the invoice header and present the message to the user as an invoice with the options to either (1) pay the charge in full by authorizing a full credit transfer amount equal to the invoiced amount, or (2) pay a partial amount toward the invoice, or (3) respond with a message disputing the invoice. Using the header information in the original message, the response message could automatically include the invoice number and other information in a standard format that could automatically interpreted by the sender's accounting software to make proper adjustments to the account. Similarly, a header for a contract document type might display with a “sign and send” button offering the receiver would digitally sign the document with a digital identification and return the signed document to the sender. Many other document types, including purchase orders, spreadsheets, surveys or polls, paginated e-books, application forms, tax forms, documents that are wholly or in part audio or video files or executable code that should be processed in a predefined way, and any number of document types and forms that are typically used in business, government, non-profit, or private transactions.

Sixth, a header might be used simply to identify to network servers that the sender is requesting notice of the intended receiver's receipt charge. This “query of charge” message would not be delivered to the potential receiver, but would simply be used to generate an automatic response from the Suma delivery subroutine providing a notice of the receiver's appropriate charge, even if that charge is zero. The service provider might collect a fee for this query.

Seventh, additional features may also be employed in each user's database, FIG. 2, to provide further control over how many commercial messages, how much receipt income is desired, and to “pull” commercial messages when they are most needed. For example, users could identify the maximum number of Suma messages they wish to receive from any particular commercial classification over the course of a week or a month. If for example, the user receives dozens of lawn fertilizer offers a week, and is indeed interested in these but simply overwhelmed by them, he might enter into a field of his charge schedule a limit on receipt of such message to no more than six per week. Alternatively, the network server could be instructed to put all such Summa messages into a queue every week and to deliver at the end of the week only those six who offered to pay the highest receipt charges. In this manner, commercial vendors could be asked to “bid” for the attention of a potential customer. Conversely, a user may set the minimum amount he desires to earn each week from receipt charges. If the desired amount is not met during the last hour, the network server would be instructed to accept the highest bidders who have authorized less than the receipt charge normally required by the user but have also chosen to leave their messages in a holding queue until such time as the receiver might be willing to accept them at their proffered rate. Similarly, commercial advertisers may pre-authorize the delivery of messages to any Suma user who will subsequently match their selection criteria. For example, a marketer of cookbooks may preauthorize sending an ad immediately, or at a preset interval, perhaps one day, after a user has made a purchase of cooking supplies. Preauthorized Suma messages would also facilitate the ability of users to pull marketing information when they need it. For example, while users are not always interested in home mortgage rates, sometimes they are very interested in finding the best mortgage rate. Normally, to discourage receipt of mortgage information they might set a high receipt charge. When they want to get information from competitive companies, however, they could lower their receipt charge to a more reasonable level. In addition, however, the Suma client could provide a special document type that represents an “announcement of interest” (Al) or “bid request” that signifies a desire to receive information, bids, or quotes on the subject matter identified. In one alternative, this AI might be broadcast to all commercial Suma users who request delivery of AI's in their category of interest. Alternatively, the AI may be processed by a central server that matches the AI request to pre-authorized messages that commercial Summa users have prepared to respond to any matching AI request. In all of these exchanges, the consumer and commercial user may set maximum delivery charges or receipt charges as best they deem. Of course, service providers might also apply additional charges.

Eighth, this invention also facilitates the use of multi-layered marketing efforts. For example, a company selling saunas might be willing to pay only five cents per potential customer in a “qualifying” mailing to a million people. The message would explain what the company was offering and promise an additional credit of $5 if the receiver, after reading this initial message was interested enough to “click here” and examine more of the company's materials. Upon activating the “click here” link, the user's Summa client would automatically generate a request for more information to be sent to the sender. The sender would then respond with a second Suma message containing additional information, including perhaps a video clip attachment, and the promised full credit transfer amount of $5. Alternatively, the customer might be directed to click through to a special advertising page at the company's internet site which would display the sales pitch and afterwards provide the user with a form to fill out, including his Suma account information to which a Summa message providing the $5 credit would be sent.

Ninth, another variation is to allow users to set receipt charges to a negative number. This signals a reverse payment, namely the receiver's authorization to pay the sender for each Suma message received. This would be useful as a means of paying for each issue of a newsletter, for example. The negative receipt charge would be compared to the negative number set in the sender's maximum receipt charge field. If the receiver's authorized payment was not sufficient, the newsletter would not be delivered. In this way, users could easily cancel a subscription by replacing the negative number with a positive number, while information providers can also be certain they collect their payments for each issue delivered.

Tenth, to strengthen security, the transfer of Summa messages would typically involve a much different communications protocol than the POP3 and SMTP methods used by standard email clients and servers. In a typical embodiment, the transfer of messages between Suma clients and the Suma network servers, and between Suma network servers, may include encryption, compression, requests to send, permissions to send, challenge and response, message hashes, certificates of authority, identity verification, and other techniques well known to computer security specialists. These techniques would be used individually or in combination to ensure that the identified sender did actually authorize the sending of funds and to ensure confidential delivery of the funds and message to the intended receiver. While the specialized Suma client would be required to generate Summa messages in accord to this secure protocol, the Summa client can also include programming to handle create, download, and read POP3/SMTP email. This backward compatible functionality allows Suma users to continue to receive POP3 email from persons on their pass through list who do not have Suma accounts and also to send SMTP messages to these same persons from their Suma client.

Eleventh, the marketing data collected in the Suma Account Databases 34 and 40 is a valuable commodity for data mining, segregation, and selects that will identify subsets of Summa users that marketers would most wish to send their commercial offers. According to this invention, this marketing data can be made available either through each individual Summa network server or it can be collected into a centralized database from which marketers may extract data. The methods of compiling, searching, and distributing data from such a database are well known to those skilled in the art and require no additional elaboration here.

Twelfth, just as HTML provides a mechanism to launch an email client to send a message to a predetermined address, special web page programming can be devised for a hyperlink to launch a Summa message transferring a predetermined credit to a predetermined user. The buyer and seller would simply both need Suma accounts. Programming for a Summa hyperlink would launch a Summa message authorizing the payment to the seller, most probably including in the message information to the seller identifying the item being purchased. In a typical application, the buyer would confirm the purchase, most probably with a password, and the Suma transaction would be completed. If a shipping address were required, this could automatically be provided from the buyer's database. This method provides an easier means of completing Internet purchases without the need for filling out contact information and revealing a credit card numbers. A similar method could be employed for a micropayment system. For example, in order to gain access to web pages containing information of value, a special hyperlink displaying the cost of following the hyperlink would, when activated, simultaneously take user to the desired page and authorize a Suma payment of the few cents, or even fractions of cents, required. In this example, the user would probably set a maximum amount, say 5 cents, that he was willing to have paid without the need of a confirming the purchase with a password. In this way Suma account users could easily have access to web sites requiring micropayments for browsing of their content.

Thirteenth, in many applications it may be useful to provide or require a digital identification (DI). For example, a DI may be provided by the sender with a contract bid, or with a filing and payment of taxes. In this case, the sender would simply choose the option of attaching the DI to the Suma message and the receiver would be able to see if any message had a DI or not. Conversely, senders might require a DI from receivers prior to delivery of the Summa message. This is analogous to sending a registered mail or a legal notice wherein the receiver must sign for delivery or even produce a government or corporate ID. To implement this option, the sender of a Summa message may be provided with the option to condition delivery upon provision of a general or specific DI. The task of supplying the DI may be automated or semi-automatic. Most typically, the receiver would electronically deposit one or more digital identifications in his Suma client or his network server so they would be ready to be used at any time. For example, the sender may require either a digital signature and/or a confirmation of identity in the form of a specific CA prior to delivery the Summa message. In this example, the message would be put into a hold queue and the network server would send a request for the required DI to the receiver's network server. If the receiver configured his end to automatically fill all DI requests, the receiver's network server would automatically send the DI to sender's network server. If required, the sender or the sender's network server would use the issuing party's public key to confirm the authenticity of the CA. Upon confirming the identity of the receiver, the queued Suma message would then be released for delivery under the usual conditions. Alternatively, if required by the sender or by the option of the receiver, the DI would only be provided when the receiver authorized delivery in each instance by manually confirming permission to provide the DI by clicking on an appropriate button or icon. In this case, the receiver would not receive the original Summa message itself at this time, but only a notice of the request for the DI, which might include the name of the requester. Typically, the notice of the request for DI prior to delivery of the queued message would be treated as a special document type that, upon display, would include buttons that allow for easy approval of the request. This request, however, could also be treated as a separate Summa message for which the appropriate receipt charge would apply.

Fourteenth, it is possible to further increase the value of the marketing data collected, and thereby the income users can receive from receipt charges, by collecting additional information about purchasing habits from other financial transactions. For example, the type of data normally collected on debit and credit card sales at a retail establishment could be linked to each user's database. Alternatively, a new type of credit or debit card issued by the service provider may be used as a token, or smart card, to authenticate a Summa transaction at a dedicated transaction terminal at the checkout lane of a retail establishment. In this example, the token might contain an encrypted CA that would be verified by the terminal, which may also provide for entry of a user's password. Upon confirmation of the sale by the user, the terminal would generate a Suma message that would pay for the purchase and upload a list of the user's purchases to the network server. In this example, the checkout terminal acts is simply a dedicated Suma client accessible to any user who identifies himself to the terminal with an appropriate encrypted token and password. Similar tokens may also be used as an additional security precaution whenever a user wants to access his Suma account from a networked device that the Summa network would recognize as not being one of his “normal” access points. Implementation of the above and similar schemes for completing financial transactions in a manner that accumulates valuable marketing data will be obvious to those skilled in the electronic arts. This invention is unique, however, in that the marketing data is accumulated to the financial benefit of the consumer.

Finally, it is important to note that while this system can be effectively implemented by means of network servers and Suma clients, it will be obvious to those skilled in the programming arts that the same general methods can be used to implement this invention through server based application software or a web based site, in a fashion similar to the way that the Hotmail web-based email site is commonly used as a substitute for using Outlook Express to view email stored on a network server.

Additionally, internet service providers may be able to waive subscription fees for user in return for a service fee levied against their user's receipt charges or fund transfers. Tech support centers can use a Suma account to collect an advance payment for a request for help. Companies may set receipt charges for the Summa accounts of their employees, and thereby collect on the value of outsiders contacting their employees. This income would help to offset the cost of providing communication tools to employees and creates added value from their employees.

As will be apparent to those skilled in computer programming, Summa accounts can easily be programmed to satisfy many standard business practices. For example, Summa accounts can be multiplexed, that is several financial accounts can be linked to a single user's address. In this case, the user might use a single Summa client to retrieve all of his messages but when sending a Summa message the user would be allowed to choose from which of the multiple financial accounts available funds should be drawn to pay the receipt charge or other payment. Conversely, the user addresses for multiple users, such as a husband and wife, could be linked to a joint financial account. The system can also be easily modified to require two or more users to authorize a payment. For example, an electronic Summa invoice might be sent to a company's accountant. Upon verifying the invoice, the accountant may then authorize the payment, but the message would not be sent directly to the receiver but would instead be automatically routed to “co-signer” for the account, the business owner. The Summa message, including the payment, would only be sent after the business owner confirmed it for delivery.

Because all the Suma account records are in an electronic format, it is also obvious that this accounting information can be easily read or imported into accounting software. Alternatively, accounting software can be incorporated into the Suma client. Upon review of what is taught in this invention, it will be readily apparent to anyone skilled in the programming and accounting arts that any standard for handling multiple accounts, multiple signers, tracking of expenses and payments, collection of customer histories, et cetera, can be accomplished or mimicked through minor variations in the programming governing general or special purpose Suma accounts.

The techniques disclosed herein produce the following advantages:
they increase the value of a user's identity and time and provide the user with greater control over the type and quantity of electronic messages received;
they correct the inherent weakness in the prior art which provided no practical means of regulating the quantity and quality of email messages received and no practical way of generating income for the user;
they reduce the impulse of users to keep their email addresses secret for fear of being inundated with unwanted email messages thereby promoting a more public posting of addresses that will facilitate appropriate communication;
they provide a new manner of engaging in financial transactions over a computer network through a system of technological and contractual business relationships between users and their service providers;
they provide a more open structure for commercial email messaging and identification of customer interests, improving rapport between businesses and customers by eliminating the sense that users are being “hassled” with unwanted email messages; and
they provide a new source of revenue for service providers, reducing the cost of their services, and opens up new avenues for business development along the model used by telephone companies, banks, and credit card companies.

### Receipt Charges for Telephone Calls

The exemplary systems depicted by FIGS. 1 and 5 can be used for sending and receiving Suma messages, including telephone calls, through a Suma system. As shown in FIG. 1, an exemplary user 20 has access to a Suma enabled device operating the Summa client 21. A Suma client 21 may comprise a telephone, cellular telephone, video conferencing equipment, etc. Other exemplary users are indicated by reference characters 22, 24 and 26, and those users have access to respective Summa clients 23, 25, etc. A Summa Server 32 stores profiles associated with a plurality of Suma users (20, 22, 24, 26, and 30). Each user's profile may include an identifier for a Suma client (e.g. telephone number or account ID) where the user can receive Suma voice calls, and the Summa Server 32 uses these identifiers to initiate voice connections. Connections may be established over any known communication medium, e.g. telephone (PSTN), internet, voice-over-IP, etc. Naturally, more than one Suma ID could be mapped to the same communication device and more than one device could be mapped to each Suma ID. One could even forward the call to multiple devices simultaneously, as this might be very helpful in the event of an emergency. When dealing with multiple devices associated with a Suma account, the user may also designate different rates for different devices (home phone or work phone, for example) with directions to block or route messages at different times of the day to one or the other device.

Operation of an exemplary embodiment wherein the system is used to connect telephone calls will be described with reference to FIG. 1. Suppose that the user 20 wishes to initiate a telephone call to the user 22. In this scenario, the user 20 uses Summa client 21 to connect to the Summa Server 32 and requests to initiate a call to the user 22. The Suma Server 32 identifies the Summa client 21, e.g. by receiving a phone number or the Suma ID associated with the Summa client 21. The Suma client 21 may provide the Summa Server 32 with an identifier associated with the user 22, e.g. a Suma ID, and the Suma Server 32 may determine the appropriate Suma client to call. For example, the profile of user 22 may contain instructions to call one Suma client during the day and another in the evening.

Alternatively, the Summa client 21 may provide an identifier associated with the Suma client 23, e.g. a telephone number. The user 20 also provides a maximum authorized receipt charge that user 20 is willing to pay for the call. The Summa Server 32 determines whether the call is authorized, according to the rules for Summa messaging, and initiates a connection between the Summa client 21 and the Suma client 23 if the call is authorized. For example, users may configure their accounts such that different fees are required for different classes of callers. For example, a user may set a very high receipt charge to receive commercial calls from marketers in categories in which the user has little interest, and set low receipt charges in categories in which the user is interested. A user may set the fee for personal calls to zero.

The Suma Server 32 may be programmed to record events such as authorized call connections in a profile associated with each Suma user. The Summa clients may include programming to distinguish between incoming Summa and non-Summa phone calls, such as by playing a distinct ring-tone for Summa calls, (e.g. a “Ka-Ching” sound). The system may be configured to provide the call recipient with information about the call, such as the caller's name and the receipt charge that will be paid. For example, a Suma client may be configured to report to a user: “You will receive $1.00 if you accept this call from Acme Corporation.” Because more than one person may share a telephone, the Summa client may be configured to request identification from the user before authorizing a call. For example, the system may be configured to deliver an automated message such as “if this is Bill, please press one to accept this Summa call from Jane.” Users may designate time windows when they are willing to accept telemarketing calls, and time windows when such calls should be blocked. When receiving a call, the system may be configured to allow the user to indicate that the caller should call back later. For example, a voice-recognition system could be used. When a call recipient receives a call, the system could prompt the user: “Say ‘accept’ if you wish to accept the call, or ‘call back later’ if you are willing to accept it at some future time and then specify when the caller might best try again, or just hang up to reject the call.”

Extensive marketing information may be collected regarding Summa users in order to enhance the revenue the user may obtain from receiving advertisements. Marketing information may be stored in the Summa user's profile so that the Summa Server 32 may perform searching and matching functions on the marketing data. In an exemplary embodiment, the user 20 may not have a specific call recipient in mind, but wants to place a call to prospective customers according to marketing criteria. For example, the user 20 may wish to place calls to any Summa users who have recently purchased a particular product. In this embodiment, the user 20 connects to the Summa Server 32 and provides his criteria. The Suma Server 32 may respond by generating a list of matching users and offering to connect to the users if the call is authorized.

FIG. 4 depicts an exemplary flow chart for determining whether a Suma message, e.g. a telephone call, is authorized. In the above example wherein the user 20 wishes to call the user 22, the user 20 is equivalent to “user 2” in FIG. 2, and the user 22 is equivalent to “user 1.” The Summa Server 32 checks whether the user 20 is on the user 22's “refused list,” and if the user 20 (or the Summa client 21) is on the “refused list” the call is unauthorized. Otherwise, the Suma Server 32 checks the profile of user 22 for a required receipt charge applicable to a call from the user 20. The receipt charge could be a fixed charge, a charge per minute based on the duration of the call, a charge related to the user device used for the transmission (i.e., home phone, cell phone, or business phone), a charge for message type, (i.e., text message, video, voice connection) or any combination thereof. If the required receipt charge of the user 22 does not exceed the maximum authorized receipt charge of the user 20, then the call is authorized. For example, an attorney, accountant, or other professional may create a Summa account and set a receipt charge equal to the professional's billing rate when receiving calls from clients. This allows the professional to receive payment for his time spent on the phone with a client, without a need for any further billing or recording of the time the parties were on the call. This system may also be used by telemarketers who pay consumers to listen to advertising, answer survey questions, etc.

If the call is authorized, the Summa Server 32 debits the receipt charge from the Summa account of the user 20, and issues a credit to the Suma account of the user 22 equal to the receipt charge (less any fees or taxes). In an exemplary embodiment, the user 20 may not have a Suma account or client, but may instead fund the call from another source, e.g. via a credit card payment.

### Targeted Advertisements Based on MED Location

In an exemplary embodiment, a Suma client may comprise a mobile electronic device (MED) and the location of a MED may be used to trigger a Suma message, e.g. an advertisement. In one embodiment, MEDs would be equipped with a location detection functionality (e.g. GPS) and location information would be reported to the Summa Server 32. The Summa Server 32 may be configured to provide advertisements to MEDs based on location. For example, an advertisement for a particular retail store may be delivered to MEDs near the store. Of course, location information could be used in conjunction with marketing criteria, receipt charges, and other features of Summa messages generally to determine whether the message is sent.

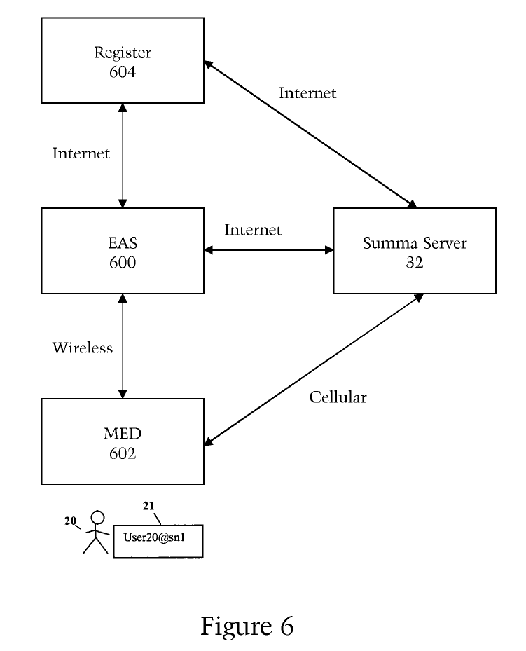

FIG. 6 depicts an exemplary embodiment for identifying the location of MEDs using a local station. The local station of FIG. 6 is an electronic advertisement station (EAS) for delivering targeted advertisements. The EAS 600 could be placed in an area where prospective customers might be located, e.g. in the vicinity of a retail store or in high-traffic areas such as an entrance to a mall. The EAS would be equipped with wireless communication systems (e.g. Bluetooth, Wi-Fi, etc) to communicate with MEDs in the area. The EAS might connect with nearby MEDs to provide advertisements through Summa messages related to retail stores in the area. Advertisements could include store location, inventory, coupons, etc. Advertisements can take many forms, including audio, video, images and text, and may be delivered via text message, voice call, web pages or any other format. The EAS may contain information and advertisements for a plurality of retail stores. The EAS may query nearby MEDs for information including Suma IDs, receipt charges and marketing data. The EAS may use this information to determine whether or not to send advertisements regarding a particular retail store to the MED. The EAS may be in communication with Summa Server 32, and may be programmed to query the Suma Server 32 for marketing data, receipt charges or other information related to a particular MED or user's Suma ID. An EAS may send advertisements directly to nearby MEDs or indirectly through Summa Server 32.

For example, an EAS 600 may detect a nearby MED 602 and establish a wireless connection via Bluetooth or a localized Wi-Fi network. The MED 602 belongs to the user 20 and includes information about the user embedded the Summa client 21. The MED 602 may report an identifier to the EAS 600, e.g. the user 20's Suma ID. The EAS 600 may connect to the Suma Server 32 and request information on the user 20, such as the user 20's buying habits and receipt charge schedule. The EAS 600 contains advertisements for a plurality of retail stores and contains criteria for each store that determines when the EAS 600 will cause an advertisement to be delivered. For example, the manager of a sporting goods store might configure the EAS 600 to deliver advertisements to users who have a history of buying sporting goods from a competitor and have a Summa message receipt charge below $0.10. Supposing the user 20 meets these criteria, the EAS 600 could contact the Suma Server 32 and request that an advertisement be delivered to the MED 602 in the form of a Summa message. For example, the EAS 600 might send a Summa message comprising a coupon to the MED 602. The EAS 600 might also connect to a check-out register 604 at the sporting goods store and provide information on the user 20, the MED 602, and the delivered coupon, so that when the user 20 goes to use the coupon at the sporting goods store, the coupon can be automatically verified and applied to the purchase, as described below. The check-out register 604 may be in communication with the Summa Server 32 to receive coupon information, e.g. via the internet.

As another example, a local station unit in a mall scans for Suma enabled MEDs within its range. In this embodiment, the Suma IDs identified are conveyed to the Summa network and ad placement decisions are automatically made at the Suma network level based on advertiser criteria and MED location. In this example, the Suma network ad placement module might identify a user entering the mall as a prior customer of a shoe store there that has not made a purchase in the last three months, or as a female in the age and income range targeted by the store. On the basis of this profile match, the Suma network generates a text message delivered to her cell phone with a specialized ring tone, of the type described above, for instance, a “You've got money” tone. On examining the cell phone display she sees that she has just received ten cents for her attention (her required Summa message delivery charge) and a coupon for 20% off any shoes in the store. The fact that she has been given this coupon would be logged in the ad placement module and added to the matching criteria to prevent delivery of the same ad, or another ad from the same store, to the same Suma user for a number of days or months determined by the advertiser. If the user goes into the store to use the coupon, she may simply provide the cashier with her Suma ID to claim the promised discount. Her ID and discount can be delivered via the internet or another network from either the ad placement unit or the Suma servers. The fact that she acted on the ad would be logged into information about her purchasing patterns for both the advertiser and the Suma servers.

As another example, a user in a shopping mall wishes to receive as many coupons as possible for restaurants in that mall, so he sets his required receipt charge to zero for coupons from restaurants in that mall. Suma Server 32 and EAS 600 may be programmed to monitor for changes in receipt charges or for some other input indicating the users desire to “pull” specific types of ads in the locality, for hotels or theatres, for example. Returning to the specific example of a user seeking restaurant coupons, Suma Server 32 and EAS 600 might perform a new check for advertisements based on this new receipt charge or other “pull” criteria, and may discover that the criteria for delivering several coupons has now been met, and thereby determine that the coupons should be sent to the user.

At times when a user does not wish to receive any advertisements, a function on the MED may be activated to block reception of any commercial, or non-commercial, Summa messages, while still allowing normal calls to be received.

### Check-Out Register Interface

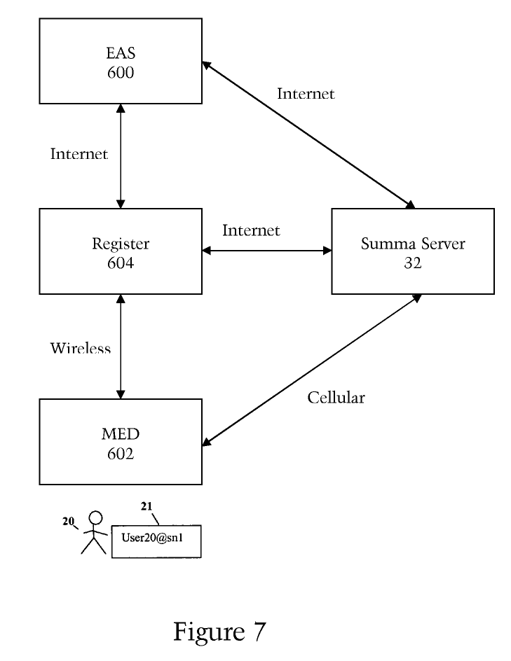

As noted above, electronic check-out registers at retail stores may be in communication with the Summa Server 32. FIG. 7 depicts an exemplary embodiment for the use of an MED to facilitate transactions at a retail store. A check-out register 604 may be configured to detect and/or communicate with an MED via wired or wireless communication. The register may query the MED for a Suma ID or coupon code. For example, the register 604 may communicate with the MED 602 to receive the user 20's Summa ID, and the register may query the Suma Server 32 for information associated with the user 20. For example, if the user 20 has received a coupon, coupon details can be provided to the register 604 by the Suma Server 32 so that the register may automatically apply the coupon to the user 20's purchase.

An MED may also be used at a retail store to initiate payment via a Suma message. For example, the check-out register 604 may receive a payment confirmation from the MED 602 and the Summa Server 32. In an exemplary embodiment, a cashier might ring up a purchase and the check-out register 604 could send a receipt to the MED 602 of the user 20 (either directly or indirectly via the Suma Server 32). The user 20 could then authorize a payment to the store based on the receipt. A payment confirmation message could be delivered to the check-out register either directly from the MED 602 or indirectly via the Suma Server 32.

A check-out register may receive information related to a Suma account via a variety of methods. For example, an MED could be equipped with a bar code that could be scanned by a register. The bar code would encode a Suma ID or other identifier. As another example, MEDs may be equipped with an RFID chip, which would transmit identification to a register. Conversely, the MED might be used to initiate the transaction by identifying the cash register, either electronically or by a posted Suma address associated with the cash register that would be manually entered into the MED by the user. Alternatively, the cash register operator might simply key in the customer's Summa address causing an electronic invoice to be delivered to the MED requesting payment. By using the MED to respond to this Suma message with an authorization to make the payment, the sale may be completed. In any event, whether by manual or an automated exchanged of Summa addresses, once the buyer's MED and the seller's cash register are able to communicate via the Suma network, the exchange of purchase orders, invoices, receipts, coupons and payments, including any credits or taxes, may be conveniently accomplished via one or more Suma transactions.

In one preferred embodiment, the cash register at a grocery store would be equipped with an ECD which would automatically detect the MED's address and would send an electronic copy of the cash register bill to the buyer's MED along with information regarding the seller's Suma account, including perhaps a subaccount associated with the particular cash register. The buyer would then be able to view the bill on his MED and see the total charge. By either a single key “Pay” keystroke, or by entry of a PIN confirmation or other process, the buyer would confirm authorization to pay the amount and the payment would be made to the seller's appropriate account and a confirmation message of payment would be delivered to the cash register for display to the check out clerk. An electronic copy of the receipt and an itemization of the purchased items might also be delivered to both the buyer's MED and home computer via the buyer's Suma account. This electronic record of the purchase could then be automatically imported into the buyer's financial tracking software. Similarly, an electronic receipt would be delivered to the store's central bookkeeping records and marketing data associated with buyer's Summa ID would be transmitted to the store's marketing database.

### Independent Payer Identification Device (IPID)

Security may be enhanced by requiring entry of a personal identification number (PIN) in order to enable secured functions (e.g. Suma transactions) from the MED. For transactions above a user defined or system minimum, a secondary password or PIN may be required.

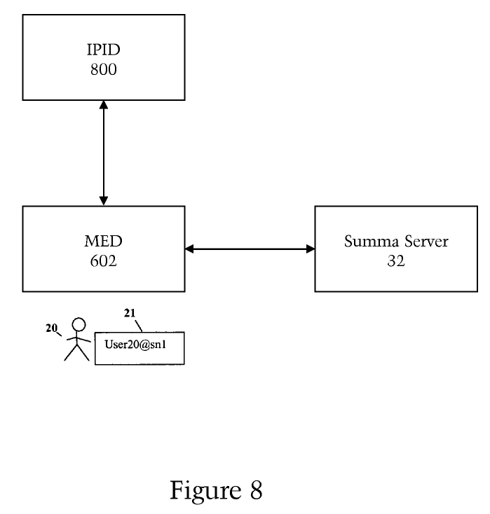

An additional level of security may be implemented by issuing the user one or more independent payer identification devices (IPID) which must be in proximity of the MED in order to enable financial transactions from the MED. FIG. 8 depicts an exemplary system for securing the use of an MED when conducting a Summa transaction by requiring that an independent payer identification device (IPID) be in proximity to the MED. In the exemplary embodiment of FIG. 8, an IPID 800 and the MED 602 belong to the Summa user 20. The IPID 500 contains a wireless transmitter, preferably a short-range wireless transmitter (e.g. an RFID chip), and the MED 602 contains a wireless receiver for communicating with the IPID (e.g. RFID detector). Suma server 32 stores an identification code associated with MED 602 and/or Suma user 20. The Suma network provider provides Summer user 20 with an IPID 800 containing the identification code. IPID 800 wirelessly transmits an electronic signal comprising the identification code to MED 602 (e.g. periodically, or when prompted by the MED). MED 602 then relays the identification code to Suma server 32. MED 602 would preferably be configured to erase the identification code from the MED's memory immediately after relaying the code. Thus, the MED will be unable to transmit the identification code without the IPID 800 in proximity to and in communication with MED 602. Suma server 32 is configured such that secured functions (e.g. Suma transactions) are possible only when the proper identification code is received from MED 602. Thus, if the MED 602 is lost or stolen, but the user 20 possesses the IPID 800, any attempts by a thief to perform financial transactions (or other secured functions) from the MED 602 will fail. The IPID may be embedded in a keychain, smart card, wallet, purse, etc. The presence of the IPID may substitute for entry of a PIN number, for convenience purposes.

In an exemplary embodiment, the MED 602 may be configured to recognize a new IPID through a “marriage” routine. For example, the Summa service provider would mail an IPID comprising an RFID device with a unique embedded identification code to a Summa user with an MED. Prior to the mailing, or during a configuration routine conducted after receipt of the IPID, the embedded RFID code would be associated with both the user's Suma address and the MED with which the Suma account was authorized to be used. Suma transactions would be disallowed if the IPID was not in proximity to the MED. Specifically, whenever a Summa transaction was attempted using the MED, the Summa network would instruct the MED to retrieve and relay the code from the IPID associated with the user's Summa account. If the code was not relayed, most likely because the IPID was not in proximity to the MED, the Suma transaction may be refused or alternative security measures may be required. For example, a picture of the user might be conveyed to the cash register clerk via the Summa network to accommodate a visual identity check.

The invention described herein can be modified and adapted in a variety of ways, as will be apparent to a person having ordinary skill in the art. In view of such exemplary modifications, the full scope of the present invention is to be defined solely by the appended claims and their legal equivalents.

What is claimed is:

1. A method comprising:
providing a memory storing a database, the database being configured to store information related to Summa accounts associated with at least one recipient and at least one caller, each of the recipient and caller Summa accounts comprising a messaging system configured to permit telephonic communication between the caller and the recipient and crediting and debiting of at least one financial account associated with the recipient and at least one financial account associated with the caller, the recipient Suma account information including at least one receipt charge required for receipt of at least one Suma telephone call directed to that account, the caller Summa account information including at least one sending fee for sending of a Summa message from the caller Summa account; and
arranging a server in communication with the memory;
configuring the server to retrieve recipient Summa account information from the database stored in the memory in response to a telephone call directed to the recipient Summa account;
comparing data associated with the telephone call to information associated with the recipient Suma account;
disposing of the telephone call based upon comparison through one of two disposition modes;
wherein the first disposition mode comprises delivering the call when the telephone call data is compatible with the recipient Suma account information; and
wherein the second message disposition mode comprises denying the call when the telephone call data is not compatible with the recipient Suma account information.

2. The method of claim 1 wherein the telephone call data comprises sending fee information associated with a caller Summa account.

3. The method of claim 2 further comprising:
comparing the receipt charge to the sending fee to determine whether the telephone call data is compatible with the recipient Summa account information.

4. The method of claim 3, wherein the telephone call is disposed of through the first disposition mode when the receipt charge does not exceed the sending fee and a second disposition mode when the receipt charge exceeds the sending fee.

5. The method of claim 4, wherein the first disposition mode comprises: (i) delivering the telephone call from the caller Summa account to the recipient; (2) debiting the caller Suma account an amount based on the receipt charge, and (3) crediting the recipient Suma account an amount based on the receipt charge.

6. The method of claim 5 wherein the receipt charge comprises a periodic rate.

7. The method of claim 5, further comprising providing the recipient of the telephone call with a unique prompt.

8. The method of claim 1 wherein the recipient Suma account information further comprises a refused list.

9. The method of claim 8 further comprising disposing of the Suma telephone call via the second disposition mode when the telephone call data matches information on the refused list.

10. The method of claim 1, wherein the telephone call data indicates the caller does not have a Summa account.

11. A method comprising:
providing a memory storing a database, wherein the database is configured to store information related to Summa accounts associated with at least one receiver and at least one sender, each of the receiver and sender Suma accounts comprising an electronic messaging system configured to permit communication between the sender and the receiver and crediting and debiting of at least one financial account associated with the receiver and at least one financial account associated with the sender, the receiver Summa account information including at least one receipt criteria of commercial categories required for receipt of a Suma message addressed to the receiver Suma account, the sender Suma account information including at least one sending criteria of commercial categories for sending of a Summa message from the sender Suma account;
providing a server with access to the memory wherein the server is configured to compare the receipt criteria to the sending criteria and dispose of the message by at least first and second disposition modes, the first disposition mode comprising transfer of the message from the sender Suma account to the receiver Suma account when the receipt criteria matches the sending criteria, the second disposition mode comprising blocking delivery of the message to the receiver Summa account when the receipt criteria does not match the sending criteria;
configuring the server to communicate with a mobile electronic device associated with the receiver;
receiving location data of the mobile electronic device; and
delivering an advertisement to the mobile electronic device via the first disposition mode based upon the location data associated with the mobile electronic device and the receipt criteria of the commercial categories associated with the at least one receiver Suma account.

12. The method of claim 11 wherein the location data comprises global positioning system (GPS) data.

13. The method of claim 11 wherein the advertisement comprises a coupon.

14. The method of claim 11 further comprising configuring the database to store a record of transfers based upon matched criteria of the commercial categories associated with one of the at least one receiver and sender Suma account.

15. The method of claim 14 wherein the step of delivering an advertisement to the mobile electronic device via the first disposition mode further comprises selecting an advertisement based upon the record of transfers.

16. The method of claim 13, further comprising:
providing a check-out register in communication with the server; and
receiving at the server billing information from the check-out register for a purchase based upon the coupon;
transmitting to the mobile device the billing information for the purchase; and
receiving authorization from the mobile electronic device to make a payment for the purchase.

17. The method of claim 16, wherein the step of receiving authorization from the mobile electronic device includes (1) receiving from the mobile electronic device an electronic signal comprising an identification code; (2) comparing the electronic signal to a unique identification code associated with the recipient Suma account; and
(3) making the payment when the received electronic signal matches the stored unique identification code.

18. A method comprising:
providing a memory storing a database, wherein the database is configured to store information related to Summa accounts associated with at least one receiver and at least one sender, each of the receiver and sender Suma accounts comprising an electronic messaging system configured to permit communication between the sender and the receiver and crediting and debiting of at least one financial account associated with the receiver and at least one financial account associated with the sender, the receiver Summa account information including at least one receipt criteria of commercial categories required for receipt of a Suma message addressed to the receiver Suma account, the sender Suma account information including at least one sending criteria of commercial categories for sending of a Summa message from the sender Suma account;
providing a server with access to the memory, wherein the server is configured to compare the receipt criteria to the sending criteria and dispose of the message by at least first and second disposition modes, the first disposition mode comprising transfer of the message from the sender Suma account to the receiver Suma account when the receipt criteria matches the sending criteria, the second disposition mode comprising returning a notice to the sender Suma account when the receipt criteria does not match the sending criteria;
configuring the server to communicate with a mobile electronic device associated with the receiver;
configuring the server to communicate with a local station associated with the sender, the local station being configured to communicate with a mobile electronic device via wireless communication; and
at the server receiving from the local station a signal indicative of a request to deliver the Summa message to the mobile electronic device.

19. The method of claim 18 wherein the Summa message comprises an advertisement.

20. The method of claim 19 wherein the advertisement comprises a coupon, and wherein the method further comprises:
at the server receiving from the local station details associated with the coupon.

21. The method of claim 18 wherein the local station communicates with the mobile electronic device through at least one of Bluetooth, Wi-Fi, and RFID.

22. The method of claim 18 wherein the local station receives from the mobile electronic device unique data associated with the receiver Summa account, and wherein the request to deliver the Summa message comprises the unique data.

23. The method of claim 18 wherein the local station receives marketing criteria from the mobile electronic device.

24. The method of claim 18 wherein the local station receives marketing criteria from the Suma server.

25. The method of claim 18 wherein the local station comprises a check-out register and the Summa message comprises billing information.

26. The method of claim 25 further comprising:
at the server receiving from the mobile electronic device a request to send a second Summa message comprising payment for a purchase;

27. A method comprising:
providing a memory storing a database, wherein the database is configured to store information related to a plurality of Suma accounts associated with a plurality of Suma users comprising at least one receiver and at least one sender, wherein the stored information comprises at least one identification code associated with a secured Suma account, the secured Summa account being associated with a mobile electronic device;
providing a server with access to the memory, the server comprising an electronic messaging system configured to permit communication between the sender and the receiver and crediting and debiting of at least one financial account associated with the receiver and at least one financial account associated with the sender;
providing to a Summa user associated with the secured Suma account an independent payer identification device comprising a transmitter for wirelessly transmitting an electronic signal comprising an identification code to a mobile electronic device;
wherein the mobile electronic device is configured to (1) receive the transmitted identification code and (2) send the identification code to the server;
at the server receiving from the mobile electronic device the identification code and a request to perform a financial transaction associated with the secured Suma account; and
comparing the received identification code to the stored identification code for the secured Suma account, and refusing to perform the requested financial transaction if the received identification code does not match the stored identification code.

28. The method of claim 26 wherein the transmitter comprises an RFID tag and the mobile electronic device comprises an RFID detector.
